(19) United States
(12) Patent Application Publication
(10) Pub. No.: US 2020/0171449 A1
(43) Pub. Date: Jun. 4, 2020

(54) MIXING DEVICE, METHOD FOR MIXING, AND METHOD FOR CLEANING A MIXING DEVICE

(71) Applicant: Robert Bosch GmbH, Stuttgart (DE)

(72) Inventors: Christian Karl Paasche, Bad Saeckingen (DE); Uwe Schmidt, Schopfheim (DE)

(21) Appl. No.: 16/636,121

(22) PCT Filed: Jun. 11, 2018
(86) PCT No.: PCT/EP2018/065260

§ 371 Date: Feb. 3, 2020

(30) Foreign Application Priority Data
Aug. 7, 2017 (DE) 10 2017 213 641.3

(51) Int. Cl. B01F 7/00; B01F 3/18; B01F 15/02; B01F 7/18; B08B 9/08; B01F 7/16; B01F 15/00

(52) U.S. Cl. CPC B01F 7/00275; B01F 3/18; B01F 15/0276; B01F 7/18; B08B 9/0813; B01F 2215/0032; B01F 7/00158; B08B 9/0808; B01F 7/1675; B01F 15/00032; B01F 15/028; B01F 7/00208

(57) ABSTRACT

The present invention relates to a mixing device (1), especially for mixing solids in a mixing vessel (2), comprising a stirring element (4) having at least two helical stirrer blades (7, 8) connected to a motor-driven shaft (5), wherein the stirrer blades (7, 8) have a first portion (10), a second portion (11) and a third portion (12), every one of these portions (10, 11, 12) has a constant gradient (m1, m2, m3) of one steepness or a gradient (m1, m2, m3) which is different from the constant gradient and has a curvature, and at least one of the constant gradients (m1, m2, m3) has a steepness different from the at least one other constant gradient (m1, m2, m3), or one of the different gradients (m1, m2, m3) has a curvature that is different from the at least one other different gradient (m1, m2, m3).

### BACKGROUND OF THE INVENTION

The present invention relates to a mixing device, in particular for mixing solids. The invention furthermore relates to a method for mixing solids by means of a mixing device. The invention furthermore relates to a method for cleaning a mixing device.

A multiplicity of mixing devices is known from the prior art.

A disadvantage of the prior art is the normally cumbersome and complex construction, which is the case in particular in mixing devices with multiple stirring axes. Here, the geometry of the stirring blades must be configured such that collisions do not occur during operation. Furthermore, most mixers cannot be used in batchwise operation over relatively long periods of time in the pharmaceutical production sector because the cumbersome construction gives rise to a large amount of dead space in gaps. The result is carryover from batch to batch and thus poor traceability in the pharmaceutical production process.

### SUMMARY OF THE INVENTION

The invention proceeds from a mixing device, from a method for mixing solids, and from a method for cleaning a mixing device.

The mixing device according to the invention serves in particular for mixing solids in a mixing vessel, having a stirring element which has at least two stirring blades which are of spiral form and which are connected to a motor-driveable shaft, wherein the stirring blades have a first portion, a second portion and a third portion. Each of the portions has a constant gradient with a steepness or has a gradient, which deviates from the constant gradient, with a curvature, wherein at least one of the constant gradients has a steepness which differs from the at least one other constant gradient, or one of the deviating gradients has a curvature which differs from the at least one other deviating gradient.

Here, the second portion is arranged between the first and third portions.

A “gradient which deviates from the constant gradients” may be understood to mean a non-constant or variable gradient.

It is preferable for the first portion to have a constant gradient, for the second portion to have a gradient which deviates from the constant gradient, and for the third portion to again have a constant gradient.

Through the provision of the mixing device, dead spaces during the mixing of the solids in the mixing vessel can be easily reduced. In other words, mixing virtually without dead spaces is made possible by means of the mixing device.

The mixing device may also be used for the granulation and/or drying of solids. The mixing device may be understood as a stirring device or mixer. The solids are preferably pharmaceutical solids, in particular filler substances and drug substances.

The stirring blades of spiral form may be understood to mean stirring blades which are of helical form.

The subclaims present preferred refinements of the invention.

The at least one constant gradient advantageously has a greater or lesser steepness than the other constant gradient. In other words, the at least one portion is of steeper or shallower form in relation to the other portion. It is furthermore advantageous if the at least one deviating gradient has a greater or lesser curvature than the other deviating gradient. In other words, the at least one portion is formed with a more or less pronounced curvature in relation to the other portion. In this way, dead spaces can be reduced through the design of the stirring blades.

It is furthermore advantageous if strippers are arranged at a first end of the stirring blades and bottom scrapers are arranged at a second end of the stirring blades. In other words, a stripper can be arranged at the end of the first portion of the stirring blade and a bottom scraper can be arranged at the end of the third portion.

By means of the strippers, also referred to as fins, it is possible, during the mixing process, to realize material transport of the solids present in the mixing vessel in a radial direction within the mixing vessel, in the direction of the motor-driveable shaft.

It is furthermore advantageous if the mixing vessel has a cylindrical running housing wall, a conically running housing wall, and a valve, wherein the conically running housing wall is arranged between the cylindrically running housing wall and the valve. A housing wall may be understood to mean a vessel wall. The valve is preferably a valve with little dead space, or preferably a valve with no dead space. The mixing vessel preferably has a processing space. Mixing of the solids can be performed in the processing space.

Aside from the motor-driveable shaft and the stirring blades of spiral form, the stirring element preferably has a transverse beam. The transverse beam preferably connects the stirring blades to the shaft. The stirring blades particularly preferably have the same shape.

It is preferable if the conically running housing wall encloses an angle α in a range from 25° to 65°, in particular of 45°, with respect to a horizontal. The horizontal is preferably parallel to the inner side/bottom side of the lid and/or to the outer side/top side of the lid and/or to the transverse beam of the stirring element.

It is furthermore advantageous if the portions of the stirring blades are arranged parallel to the conically running housing wall, wherein the stirring blades are of the same width in all portions. Dead spaces in the mixing vessel can be reduced in this way. A spacing between the portions of the respective stirring blade and the conical housing wall preferably amounts to 1 to 10 mm, preferably 5 mm. Preferably, a width of the stirring blades amounts to approximately 5% of the diameter of the cylindrical housing wall and is constant over the entire length of the stirring blades.

It is furthermore advantageous if the strippers are arranged parallel to the cylindrically running housing wall and/or the bottom scrapers have a shape which is adapted to the shape of the valve. In this way, dead spaces can be additionally reduced through the design of the strippers and bottom scrapers.

The strippers preferably run parallel to the cylindrical housing wall. A spacing between the stripper of the respective stirring blade and the cylindrical housing wall preferably amounts to 1 to 10 mm, preferably 5 mm.

The strippers are preferably formed so as to be beveled at an angle θ at an axially running longitudinal side, wherein the angle θ encloses a range from 20° to 60°, in particular of 40°.

It is particularly preferable if a greatest width of the strippers on the side averted from the direction of rotation is smaller preferably by a factor of 0.3 to 0.7, preferably 0.5, than the width of the stirring blades.

It is furthermore advantageous if the mixing device has a lid which is mounted onto the mixing vessel, wherein at least one flow disrupter which projects into the mixing vessel is arranged on the lid, and wherein the flow disrupter has a bracket and a baffle plate. In this way, improved mixing of the solids can be achieved. The baffle plate is preferably inclined at an angle ϵ in a range from 15° to 55°, in particular of 35°, with respect to the horizontal. Preferably, the baffle plate is inclined at an angle φ in a range from 15° to 45°, in particular of 30°, with respect to a straight line running through the axis of rotation of the shaft.

It is furthermore advantageous if the bracket has a sensor. The sensor is preferably a temperature sensor, an integrated near infrared (NIR) sensor, or a UV spectrometer. In this way, it is possible to easily realize quality monitoring (temperature, yield, moisture content, particle size, lump formation) in the mixing device during and/or after the respective mixing process. Structural space can furthermore be saved. Information regarding the flow characteristics and the shear characteristics of the solids can be determined on the basis of the data from the temperature measurement.

It is preferable if at least one cleaning nozzle which is extendable to the inside of the mixing device is arranged on the lid. An introduction of cleaning liquid to the inside of the mixing device can be performed particularly easily in this way.

The mixing device preferably has at least one filter between an inlet opening and a dosing means. Ventilation and/or aeration of the processing space can be easily made possible in this way.

The mixing device preferably has an inspection glass in the lid for inspections or measurements of quality-relevant measurement variables (for example homogeneity, moisture content, particle size, temperature).

The mixing device preferably has a lifting/pivoting device which is connected to the lid. An opening and closing of the mixing vessel can be performed by means of the lifting/pivoting device.

The method according to the invention for mixing solids by means of a mixing device has the successive steps:
dosing filler substances through at least one first inlet opening into the mixing vessel of the mixing device during a rotation of the stirring element,
dosing drug substances through the at least one inlet opening and/or a second inlet opening into the mixing vessel of the mixing device during the rotation of the stirring element,
mixing the filler substances and the drug substances,
reducing the rotational speed of the stirring element and, in response thereto,
conveying the powder mixture composed of the filler substances and the drug substances out of the mixing device through at least one outlet opening of the mixing vessel, wherein the stirring element continues to rotate at a reduced rotational speed, and wherein the conveyance is realized pneumatically and/or gravimetrically.

In detail, the mixing process may take place as described below:

The solids, which are preferably filler substances (excipient) and drug substances (for example high-potency API) are present in powder form. The powders are transported pneumatically, preferably gravimetrically, from the dosing means to at least one inlet opening for API and excipient. The inlet opening is preferably arranged in the lid or in the housing wall of the mixing vessel.

The composition of the mixture can be realized in a highly accurate manner, because the mixing device can be operated with a low stirrer rotational speed in the receiving mode for such a length of time that is required for highly exact dosing. The stirring element may in this case already be rotating in a mixing direction.

The mixing direction is the direction in the case of which the powder must slide upward on the top side of the stirring blades because the stirring element moves said top side counter to the powder fill. In order that the mixing time is very short and small amounts of high-potency API can be distributed in an effective manner already during the dosing process, it is possible, in a first phase of the dosing process in the range from greater than 0 to 30 seconds, for exclusively filler substances to be dosed into the mixing vessel of the mixing device, whilst the stirring element levels out and already premixes the fill with a slow rotational speed. It is thereby prevented that a part of the already small amount of drug substances adheres, in cases of adverse substance characteristics, to metallic surfaces of the stirring element, of the housing wall and/or of the valve.

In a second phase, the dosing of the drug substances can then additionally begin, wherein, in this case, too, the stirring element is rotated at an expediently predefined speed, and the inlet opening for the drug substances is ideally situated above the powder bed composed of filler substances. After completion of the dosing, the stirring element can rotate at the full required mixing speed, but in a shortened time period because a major part of the substances has already been mixed during the dosing process.

It is preferably also possible, after the completion of the mixing process, which is defined through the specification of a time or ideally by the attainment of a termination criterion, for the stirring element to reduce its speed and for the valve at the outlet opening to be opened. The powder mixture is conveyed gravimetrically or pneumatically, preferably a combination of both mechanisms, out of the mixer, wherein the stirring element continues to rotate, with an assisting action, in the mixing direction.

Here, the stirring element may rotate at the mixing speed or at some other expediently predefined speed. Air for the purposes of assisting transport can additionally be introduced via the filter situated at the connection between inlet opening and dosing means. Air for the purposes of assisting transport may optionally also be added via an opening provided specifically for the purpose, if the pressure loss across the filter would be too high. Optional valves at one of the inlet openings can prevent an uncontrolled ingress of materials from the dosing means to the inside of the mixing device owing to an overly intense vacuum during the pneumatic evacuation.

A dosing of different solids (powders) is preferably performed in a time period from 1 to 8 minutes through at least one inlet opening. The dosing may be performed by means of the powder from dosing means or similar components connected to the inlet opening. A homogenization of the powder mixture composed of the solids is preferably performed during the dosing process by slow mixing. In this way, a fill cone that could block the inlet opening can be avoided.

It is furthermore preferable for mixing of the different solids to be performed within 0.5 to 5 minutes, through the formation of vertical, elliptical flows between shaft and housing wall. Here, the powder mixture may flow upward at the housing wall and move downward again in the vicinity of the shaft. Here, the stirring element is shaped so as to move the powder mixture as gently as possible without thereby introducing more shear and energy into the powder mixture than is necessary. A significant local temperature increase of the powder mixture is thus avoided even in the case of high rotational speeds and short mixing times. The special design (spiral shape) of the stirring element permits efficient vertical transport of the powder mixture upward at the housing wall.

The method according to the invention for cleaning a mixing device, having at least one cleaning nozzle which is arranged on a lid of the mixing device and which is extendable to the inside of the mixing device, has the successive steps:
feeding a cleaning liquid into the mixing vessel of the mixing device by means of the cleaning nozzle, wherein the stirring element rotates alternately firstly in a first direction of rotation and then in a second direction of rotation counter to the first direction of rotation at least once,
conveying the cleaning liquid, with powder mixture present therein, through at least one outlet opening of the mixing vessel, and
rinsing the mixing vessel with deionized water.

In detail, the cleaning method may take place as described below:

Prior to the cleaning, the mixer can be emptied virtually without residue so as not to waste any valuable drug substance or API. By means of the extendable nozzles, a cleaning liquid, preferably water or water with cleaning additives, can be fed into the mixing vessel of the mixing device. Here, the stirring element rotates with an arbitrary speed and sequence in and counter to the mixing direction. Here, the valve at the outlet opening may initially remain closed until such time as the mixing vessel has been 50-80% filled. The rotation generates a more intense cleaning action at the housing wall. The sudden reversal of the direction of rotation generates turbulence and cleans the stirring element and the flow disrupter. The rotational movement generates a water spout. This enables cleaning liquid to be transported to the lid, and cleans the latter. During the further course of the cleaning, the valve can then be opened to an arbitrary extent, whereby the cleaning liquid with powder residues present therein can exit the mixing device.

The above-described process may be performed with such a frequency and for such a length of time as is considered necessary for successful cleaning.

After wet cleaning of the mixing vessel of the mixing device has been performed, this may optionally be opened and manually subsequently dried. Ideally, it is possible instead for drying air to be fed to the mixing device, at a connection provided specifically for this purpose in the lid, or at the connection between inlet opening and dosing means. Here, the valve at the outlet opening of the mixing device is opened to a desired extent.

During the cleaning process with a cleaning liquid, the valve of the mixing device may be closed, may remain open, and ideally may be opened and closed again arbitrarily often as required in order to thereby firstly prevent overfilling of the mixing vessel and secondly particularly advantageously also clean the valve. Furthermore, the stirring element may advantageously rotate during the cleaning process in order to intensify the cleaning action by means of impetus introduced into the cleaning liquid. It may be particularly advantageous here if the stirring element also moves in the opposite direction of rotation.

Through a provision of identical nozzles for cleaning liquid and drying, an air flow composed of dry air, preferably additionally heated air, can be conducted into the processing space for the purposes of drying after the cleaning process. The air required for the purposes of drying is preferably introduced as required at the connection of inlet opening and dosing means.

### BRIEF DESCRIPTION OF THE DRAWINGS

Exemplary embodiments of the invention will be described in detail below with reference to the accompanying drawing, in which:

FIG. 1 shows a schematic section through an embodiment according to the invention;

FIG. 2 shows a plan view of the embodiment according to the invention from FIG. 1;

FIG. 3 shows a schematic section through the embodiment according to the invention from FIG. 1 with further components.

### DETAILED DESCRIPTION

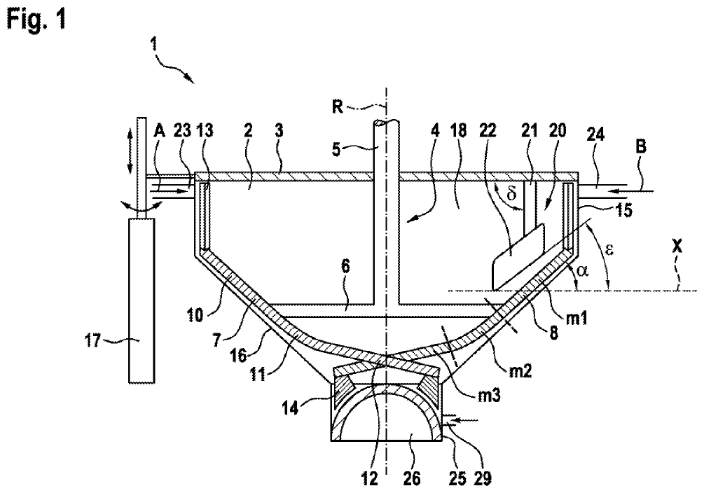

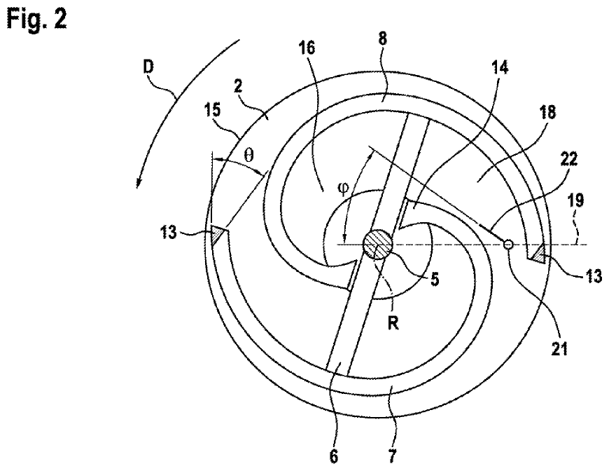

FIG. 1 shows a schematic section through a mixing device 1 according to the invention, and FIG. 2 shows a plan view of the mixing device 1 from FIG. 1.

The mixing device 1 serves preferably for the mixing of solids. Furthermore, the mixing device 1 may also be used for the granulation of solids.

The mixing device 1 has a mixing vessel 2, a lid 3 mounted onto the mixing vessel 2, and a stirring element 4. The mixing vessel 2, which is formed as one piece, has a housing wall 15, 16, which has a cylindrical housing wall region 15 and, arranged below the latter, a conical or funnel-shaped housing wall region 16. The ratio of the heights of the upper cylindrical housing wall 15 to the lower conical housing wall 16 is preferably greater than 1:2 and preferably in the range 1:3 to 1:4. A diameter of the cylindrical housing wall 15 is preferably greater, at least by a factor of 5, ideally by a factor of 6 to 8, than the diameter of the conical housing wall 16 in the outlet region (outlet opening 26). The mixing vessel 2 has a processing space 18 which, in the plane of the drawing, is delimited to the side by the housing wall 15, 16, upwardly by a removable lid 3, and downwardly by a valve 25 with little dead space.

The stirring element 4 has a motor-driveable shaft 5, a transverse beam 6 and two stirring blades 7, 8 which are of spiral form. The transverse beam 6 connects the stirring blades 7, 8 to the shaft 5. The stirring blades 7, 8 have the same shape. The stirring blades 7, 8 have a first portion 10, a second portion 11 and a third portion 12. The stirring blades 7, 8 have a constant gradient m1 in the first portion 10, a constant gradient m3 in the third portion 12, and a gradient which deviates from the constant gradients ml, m3, specifically a variable gradient m2, in the interposed second portion 11.

The gradient m2 of the second portion 11 may follow a mathematical function and has a curvature. The first gradient ml has a greater steepness than the third gradient m3. In other words, the first portion 10 is of steeper or more pronounced form in relation to the third portion 12. Alternatively, the first gradient ml may also have a lesser steepness than the third gradient m3. In other words, the first portion 10 would then be of shallower or less pronounced form in relation to the third portion 12.

The mixing vessel 2 has the conically running housing wall 16. The first portion 10 is arranged parallel to the conically running housing wall 16. A spacing between the first portion 10 of the respective stirring blade 7, 8 and the conical housing wall 16 amounts to preferably 1 to 10 mm, preferably 5 mm. A width of the stirring blades 7, 8 amounts to approximately 5% of the diameter of the cylindrical housing wall 15 and is constant over the entire length of the stirring blades 7, 8. The conically running housing wall 16 encloses an angle α in a range from 25° to 65°, in particular of 45°, with respect to a horizontal X. The horizontal X is in this case arranged parallel to the inner side/bottom side, the outer side/top side of the lid and to the central axis of the transverse beam 6 of the stirring element 4.

In each case one stripper 13 is arranged at a first end of the stirring blades 7, 8. A greatest width of the strippers 13 on the side averted from the direction of rotation D is smaller, preferably by a factor of 0.3 to 0.7, preferably of 0.5, than the width of the stirring blades 7, 8. At a second end of the stirring blades 7, 8, there is arranged in each case one bottom scraper 14. The strippers 13 are formed so as to be beveled at an angle θ at an axially running longitudinal side, wherein the angle θ is inclined in a range from 20° to 60°, in particular of 40°.

Furthermore, the mixing vessel 2 has the cylindrically running housing wall 15. The strippers 13 run parallel to the cylindrically running housing wall 15. The bottom scrapers 14 run, at least in certain portions, parallel to the cylindrically running housing wall 15. Furthermore, the bottom scrapers 14 have a shape which is adapted to the geometry of the valve 25 at the outlet opening 26.

At least one flow disrupter 20 with a bracket 21 and a baffle plate 22 is arranged on the lid 3. The flow disrupter 20 projects into the mixing vessel 2. The baffle plate 22 is inclined relative to the horizontal X at an angle ϵ in a range from 15° to 55°, in particular of 35°. The baffle plate 22 is inclined at an angle φ in a range from 15° to 45°, in particular of 30°, with respect to a straight line 19 running through the axis of rotation R of the shaft 4.

The mixing device 1 has a first inlet opening 23, a second inlet opening 24 and an outlet opening 26. The first inlet opening 23 and the second inlet opening 24 are arranged on the mixing vessel 2 in the region of the cylindrical housing 15. Filler substances A can be conveyed into the mixing vessel 2 through the first inlet opening 23. Drug substances B can be conveyed into the mixing vessel 2 through the second inlet opening 24. The outlet opening 26 is arranged at the lower end of the valve 25, which has little dead space, of the mixing device 1. The valve 25 which has little dead space may be constructed in accordance with the principle of a ballcock, or of a segmented ballcock. The valve 25 preferably has at least one opening 29 for the introduction of transport air.

In a method for mixing solids by means of the mixing device 1, the following successive steps are performed:
dosing filler substances A through the first inlet opening 23 into the mixing vessel 2 of the mixing device 1 during a rotation of the stirring element 4,
dosing drug substances B through the second inlet opening 24 into the mixing vessel 2 of the mixing device 1 during the rotation of the stirring element 4,
mixing the filler substances A and the drug substances B,
reducing the rotational speed of the stirring element 4 and, in response thereto,
conveying the powder mixture composed of the filler substances A and the drug substances B out of the mixing device 1 through at least one outlet opening 26 of the mixing vessel 2, wherein the stirring element 4 continues to rotate at a reduced rotational speed, and wherein the conveyance is realized pneumatically and/or gravimetrically.

The mixing device 1 has a lifting/pivoting device 17 which is connected to the lid 3. An opening and closing of the mixing vessel 2 can be performed by means of the lifting/pivoting device 17.

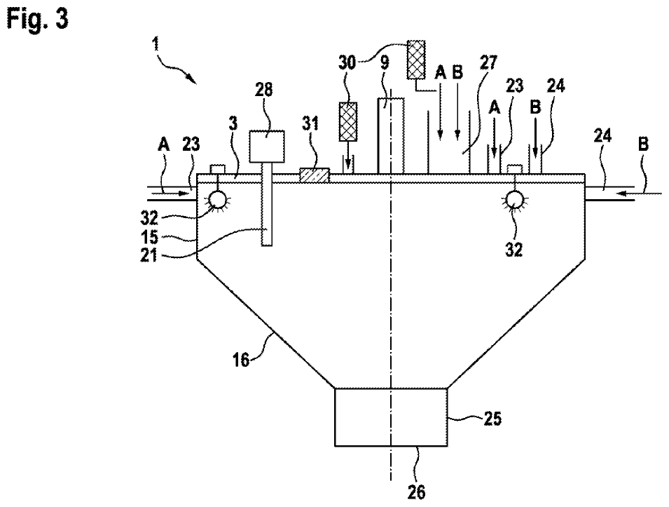

FIG. 3 shows the mixing device from FIG. 1 with further components.

Aside from the first inlet opening 23 and the second inlet opening 24, still further first inlet openings 23 and second inlet openings 24 are provided on the lid 3.

Optionally or in addition, the mixing device 1 may in each case also have an inlet opening 27 for granulate or pellets. Furthermore, a bidirectionally permeable filter 30 may be provided in the lid 17 of the mixing device 1 or at the connection between inlet opening 27 and dosing means (not shown) in order that displaced air can escape and drawn-in air can flow into the mixing apparatus 1.

A UV or NIR sensor 28 is arranged on the bracket 21. Furthermore, the mixing device 1 has an inspection glass 31 in the lid 3 for inspections or measurements of quality-relevant measurement variables (for example homogeneity, moisture content, particle size, temperature). On the lid 3, there are arranged two cleaning nozzles 32 which are extendable to the inside of the mixing device 1 and which serve for the feed of cleaning liquid into the mixing vessel 2.

The mixing device 1 is closed off at its outlet opening 26 by the valve 25, which is configured to reduce dead spaces in the processing space 18, or which is shaped such that the stirring element 4 with its bottom scrapers 14 can perform its mixing action throughout.

In a method for cleaning the mixing device 1, the following successive steps are performed:
feeding a cleaning liquid into the mixing vessel 2 of the mixing device 1 by means of the cleaning nozzle 32, wherein the stirring element 4 rotates alternately firstly in a first direction of rotation D and then in a second direction of rotation counter to the first direction of rotation D at least once,
conveying the cleaning liquid, with powder mixture present therein, through at least one outlet opening 26 of the mixing vessel 2, and
rinsing with deionized water.

Subsequent drying of the mixing device 1 may be performed after the described steps. For this purpose, an inlet opening 23, 24 or the opening 27 may be used to convey drying air to the inside of the mixing device 1.

1. A mixing device (1) for mixing in a mixing vessel (2), the mixing device having a stirring element (4) which has at least two stirring blades (7, 8) which are of spiral form and which are connected to a motor-driveable shaft (5), wherein the stirring blades (7, 8) each have a first portion (10), a second portion (11) and a third portion (12), wherein each of the portions (10, 11, 12) has a constant gradient (m1, m2, m3) with a steepness or has a non-constant gradient (m1, m2, m3), which deviates from the constant gradient, with a curvature, and wherein
at least one of the portions has a first constant gradient (m1, m2, m3) with a steepness which differs from a second constant gradient (m1, m2, m3) of another one of the portions, or
at least one of the portions has a first non-constant gradient (m1, m2, m3) with a curvature which differs from the a second non-constant gradient (m1, m2, m3) of another one of the portions.

2. The mixing device (1) as claimed in claim 1, wherein the first constant gradient (m1, m2, m3) has a greater or lesser steepness than the second constant gradient (m1, m2, m3) or wherein the first non-constant gradient (m1, m2, m3) has a greater or lesser curvature than the second non-constant gradient (m1, m2, m3).

3. The mixing device (1) as claimed in claim 1, wherein strippers (13) are arranged at a first end of each of the stirring blades (7, 8), and bottom scrapers (14) are arranged at a second end of each of the stirring blades (7, 8).

4. The mixing device (1) as claimed in claim 1, wherein the mixing vessel (2) has a cylindrically running housing wall (15), a conically running housing wall (16), and a valve (25), wherein the conically running housing wall (16) is arranged between the cylindrically running housing wall (15) and the valve (25).

5. The mixing device (1) as claimed in claim 4, wherein the portions (10, 11, 12) of the stirring blades (7, 8) are arranged parallel to the conically running housing wall (16), and wherein the stirring blades (7, 8) are of the same width in all portions.

6. The mixing device (1) as claimed in claim 4, wherein strippers (13) are arranged at a first end of each of the stirring blades (7, 8), and bottom scrapers (14) are arranged at a second end of each of the stirring blades (7, 8), wherein the strippers (13) are arranged parallel to the cylindrically running housing wall (15) and/or the bottom scrapers (14) have a shape which is adapted to the shape of the valve (25).

7. The mixing device (1) as claimed in claim 1, furthermore having a lid (3) which is mounted onto the mixing vessel (2), wherein at least one flow disrupter (20) which projects into the mixing vessel (2) is arranged on the lid (3), wherein the flow disrupter (20) has a bracket (21) and a baffle plate (22).

8. The mixing device (1) as claimed in claim 7, wherein the bracket (21) has a sensor (28).

9. A method for mixing solids by means of a mixing device (1) as claimed in claim 1, having the, the method comprising the following successive steps:
dosing filler substances (A) through at least one first inlet opening (23, 24, 27) into the mixing vessel (2) of the mixing device (1) during a rotation of the stirring element (4),
dosing drug substances (B) through the at least one inlet opening (23, 24, 27) and/or a second inlet opening (23, 24, 27) into the mixing vessel (2) of the mixing device (1) during the rotation of the stirring element (4),
mixing the filler substances (A) and the drug substances (B) in the mixing vessel,
reducing the rotational speed of the stirring element (4) and, in response thereto,
conveying a powder mixture composed of the filler substances (A) and the drug substances (B) out of the mixing device (1) through at least one outlet opening (26) of the mixing vessel (2), during which the stirring element (4) continues to rotate at a reduced rotational speed, and wherein the conveying is done pneumatically and/or gravimetrically.

10. A method for cleaning a mixing device (1) as claimed in claim 1, having at least one cleaning nozzle (32) which is arranged on a lid (3) of the mixing device (1) and which is extendable to an inside of the mixing device (1), the method comprising the following successive steps:
feeding a cleaning liquid into the mixing vessel (2) with the cleaning nozzle (32), during which the stirring element (4) rotates alternately firstly in a first direction of rotation (D) and then in a second direction of rotation counter to the first direction of rotation (D) at least once,
conveying the cleaning liquid, with powder mixture present therein, through at least one outlet opening (26) of the mixing vessel (2), and
rinsing the mixing vessel (2) with deionized water.

11. A mixing device (1)for mixing in a mixing vessel (2), the mixing device having a stirring element (4) which has at least two stirring blades (7, 8) which are of spiral form and which are connected to a motor-driveable shaft (5), wherein the stirring blades (7, 8) each have a first portion (10), a second portion (11) and a third portion (12), wherein each of the portions (10, 11, 12) has a constant gradient (m1, m2, m3) with a steepness or has a non-constant gradient (m1, m2, m3), which deviates from the constant gradient, with a curvature, and wherein
at least one of the portions has a first constant gradient (m1, m2, m3) with a steepness which differs from a second constant gradient (m1, m2, m3) of another one of the portions.

12. The mixing device (1) as claimed in claim 11, wherein the first constant gradient (m1, m2, m3) has a greater or lesser steepness than the second constant gradient (m1, m2, m3).

13. A mixing device (1)for mixing in a mixing vessel (2), the mixing device having a stirring element (4) which has at least two stirring blades (7, 8) which are of spiral form and which are connected to a motor-driveable shaft (5), wherein the stirring blades (7, 8) each have a first portion (10), a second portion (11) and a third portion (12), wherein each of the portions (10, 11, 12) has a constant gradient (m1, m2, m3) with a steepness or has a non-constant gradient (m1, m2, m3), which deviates from the constant gradient, with a curvature, and wherein
at least one of the portions has a first non-constant gradient (m1, m2, m3) with a curvature which differs from the a second non-constant gradient (m1, m2, m3) of another one of the portions.

14. The mixing device (1) as claimed in claim 13, wherein the first non-constant gradient (m1, m2, m3) has a greater or lesser curvature than the second non-constant gradient (m1, m2, m3).
